(19) United States
(12) Patent Application Publication
(10) Pub. No.: US 2023/0214161 A1
(43) Pub. Date: Jul. 6, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Kazunori OZEKI, Kanagawa (JP)

(73) Assignee: FUJIFILM Business Innovation Corp., Tokyo (JP)

(21) Appl. No.: 17/939,909

(22) Filed: Sep. 7, 2022

(30) Foreign Application Priority Data
Jan. 6, 2022 (JP) 2022-000984

(51) Int. Cl. G06F 3/12

(52) U.S. Cl. CPC G06F 3/1224; G06F 3/1212; G06F 3/1288

(57) ABSTRACT

An information processing apparatus includes a processor configured to: in a case where an intended image forming device is caused to perform printing of an image indicated by print data via a server device in a manner that the print data is transmitted to the server device in response to an instruction from a user while the print data is held in a storage unit, and then a printing instruction is performed on the image forming device by the user, and printing with the print data has been ended at a predetermined timing, execute a process of deleting the print data from the storage unit.

### CROSS-REFERENCE TO RELATED APPLICATIONS

This application is based on and claims priority under 35 USC 119 from Japanese Patent Application No. 2022-000984 filed Jan. 6, 2022.

### BACKGROUND

### (i) Technical Field

The present invention relates to an information processing apparatus, a non-transitory computer readable medium storing an information processing program, and an information processing method.

### (ii) Related Art

JP6090020B discloses an image forming system for the purpose of, in a case where an image forming device connected to an information system that performs a first authentication acquires print data from a print service system that performs a second authentication and performs printing, enabling management of a process related to the printing by using user identification information in the first authentication and enabling use of identification information temporarily issued, as identification information of a user for the first authentication.

The image forming system includes a management device and one or more image forming devices connected to a system in a specific organization that performs the first authentication. In the image forming system, the management device further includes a unit that receives an input of user setting information including a first information being user identification information to be registered in the system, second information being user identification information in a service system on a cloud that performs the second authentication, and identification information of a logical printer in the service system on a cloud that is a registration destination of the user and performs the second authentication. In the image forming system, the management device further includes a unit that generates correspondence relationship information representing a correspondence relationship between the first information and the second information in the user setting information, and stores the generated correspondence relationship information in a correspondence relationship storage device that is accessible from the image forming device in the system in the specific organization. In the image forming system, the management device further includes a user setting unit that accesses the service system on the cloud, and sets the second information in the user setting information, in the logical printer as the identification information of a user who can use the logical printer corresponding to the identification information of the logical printer, which is included in the user setting information.

On the other hand, in the image forming system, the image forming device includes a print data acquisition unit that acquires print data including the second information from the logical printer, and a control unit that controls printing processing of the acquired print data by using the second information in the acquired print data and the first information with reference to the correspondence relationship information. The image forming system is characterized in that it is possible to use the user identification information temporarily issued, in the system in the specific organization, as the first information.

JP6672596B discloses an image forming device for the purpose of eliminating a need to specify a request destination for a registration process for enabling use of the image forming device via a service system on a cloud.

The image forming device includes a first information reception unit that receives, from a user, first information being identification information of the user in a system in a specific organization including an image forming device that performs a first authentication, and a second information reception unit that receives, from the user, second information being identification information of the user in the service system on the cloud that performs second authentication. The image forming device further includes an association storage unit that stores the first information and the second information in association with each other, and a use registration unit that registers the second information as identification information of a user using the image forming device, in the service system by using identification information of the image forming device in the service system. The image forming device includes an acquisition unit that acquires print data including the second information from the service system, and a control unit that obtains, from the association storage unit, first information associated with the second information in the acquired print data and controls printing processing of the print data acquired by the acquisition unit, by using the obtained first information.

JP5299534B discloses an image forming device for the purpose of, in a case where an image forming device connected to an information system that performs a first authentication acquires print data from a print service system that performs a second authentication, and performs printing, enabling management of a process related to the printing, by using user identification information in the information system.

The image forming device includes a unit that acquires print data including second information being user identification information in the system, from a logical printer in the service system on the cloud that performs the second authentication. The image forming device includes a control unit that controls the printing processing of the acquired print data using the first information corresponding to the second information in the acquired print data, with reference to correspondence relationship information between the second information and first information being user identification information in a system in a specific organization including an image forming device that performs the first authentication.

### SUMMARY

Aspects of non-limiting embodiments of the present disclosure relate to an information processing apparatus, a non-transitory computer readable medium storing an information processing program, and an information processing method capable of avoiding continuous holding of print data and suppressing pressure on storage capacity for holding the print data.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to: in a case where an intended image forming device is caused to perform printing of an image indicated by print data via a server device in a manner that the print data is transmitted to the server device in response to an instruction from a user while the print data is held in a storage unit, and then a printing instruction is performed on the image forming device by the user, and printing with the print data has been ended at a predetermined timing, execute a process of deleting the print data from the storage unit.

### BRIEF DESCRIPTION OF THE DRAWINGS

Exemplary embodiment(s) of the present invention will be described in detail based on the following figures, wherein:

FIG. 1 is a block diagram illustrating an example of a configuration of an information processing system according to an exemplary embodiment;

FIG. 2 is a block diagram illustrating an example of a hardware configuration of an information processing apparatus in the exemplary embodiment;

FIG. 3 is a block diagram illustrating an example of a functional configuration of the information processing apparatus in the exemplary embodiment;

FIG. 4 is a block diagram illustrating an example of a hardware configuration of a control unit in an image forming device according to the exemplary embodiment;

FIG. 5 is a schematic diagram illustrating an example of a configuration of a server print information database according to the exemplary embodiment;

FIG. 6 is a schematic diagram illustrating an example of a configuration of a printing-source print information database according to the exemplary embodiment;

FIG. 7 is a flowchart illustrating an example of first information processing according to the exemplary embodiment;

FIG. 8 is a front view illustrating an example of a print reception screen according to the exemplary embodiment;

FIG. 9 is a flowchart illustrating an example of printing processing according to the exemplary embodiment;

FIG. 10 is a front view illustrating an example of a printing instruction screen according to the exemplary embodiment;

FIG. 11 is a flowchart illustrating an example of second information processing according to the exemplary embodiment;

FIG. 12 is a flowchart illustrating an example of third information processing according to the exemplary embodiment;

FIG. 13 is a flowchart illustrating an example of second information processing according to another exemplary embodiment; and

FIG. 14 is a flowchart illustrating an example of third information processing according to the other exemplary embodiment.

### DETAILED DESCRIPTION

Hereinafter, exemplary embodiments for carrying out the present invention will be described in detail with reference to the drawings. In the present exemplary embodiment, a case where the present invention is applied to an information processing system that provides a cloud print service will be described. The cloud print service referred to here refers to a service in which an information processing apparatus causes an intended image forming device to perform printing of an image indicated by print data via a server device in a manner that the print data is transmitted to the server device configured as a cloud server in response to an instruction from a user while holding the print data in a storage unit, and then a printing instruction is performed on the image forming device by the user.

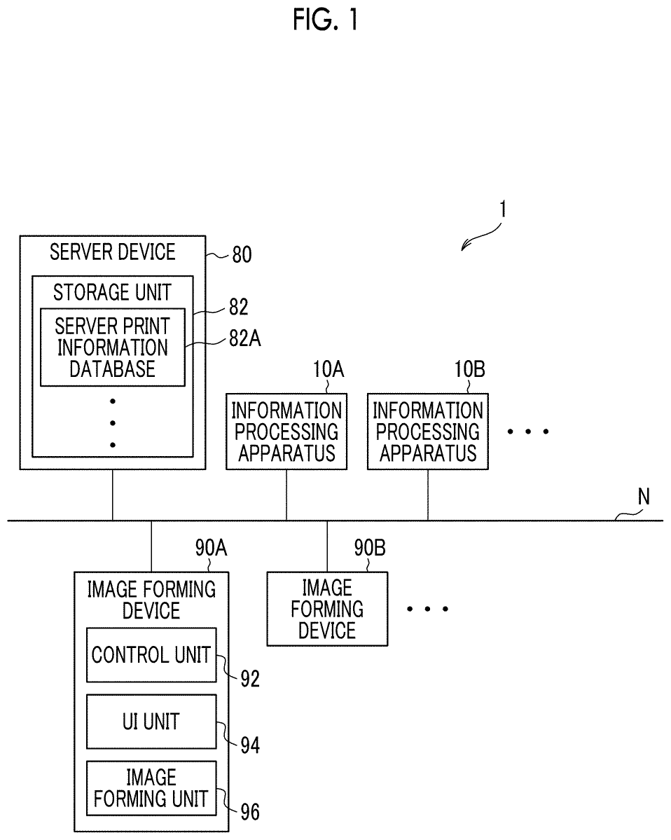

First, the configuration of an information processing system 1 according to the present exemplary embodiment will be described with reference to FIG. 1. FIG. 1 is a block diagram illustrating an example of the configuration of the information processing system 1 according to the present exemplary embodiment.

As illustrated in FIG. 1, the information processing system 1 according to the present exemplary embodiment includes a plurality of information processing apparatuses 10A, 10B, . . . , a server device 80, and a plurality of image forming devices 90A, 90B, In a case where the information processing apparatuses 10A, 10B, are described without distinguishment, the information processing apparatuses 10A, 10B, . . . are simply collectively referred to as an “information processing apparatus 10” below. In addition, in a case where the image forming devices 90A, 90B, . . . are described without distinguishment, the image forming devices 90A, 90B, are simply collectively referred to as an “image forming device 90” below.

Examples of the information processing apparatus 10 include various computers such as a personal computer and a server computer. In particular, the information processing apparatus 10 may be in a form in which a mobile terminal such as a smartphone, a tablet terminal, or a portable information terminal is applied from the viewpoint of convenience. Further, in the present exemplary embodiment, a cloud server is applied as an example of the server device 80 as described above. The present disclosure is not limited to this. A form in which a server other than the cloud server or another information processing apparatus is applied as the server device 80 may be made.

Further, in the present exemplary embodiment, as the image forming device 90, an image forming device having only an image printing function is applied. The present disclosure is not limited to this form. A form in which an image forming device having an image printing function and an image scanning function and another image forming device such as a digital multifunction device having an image printing function, an image scanning function, an image transmission function, and the like is applied as the image forming device 90 may be made.

All the image forming devices 90A, 90B, . . . are not limited to having the identical specifications. Services that can be performed may vary, items settable in the service may vary, and equipped optional items may vary.

The information processing apparatus 10, the server device 80, and the image forming device 90 are connected to each other via a network N. Each information processing apparatus 10, the server device 80, and each image forming device 90 can communicate with each other via the network N. In the present exemplary embodiment, a public communication line such as the Internet or a telephone line network is applied as the network N, but the present disclosure is not limited to this form. For example, as the network N, communication lines in a company such as a local area network (LAN) and a wide area network (WAN) may be applied, and a combination of the communication line in the company and the public communication line may be applied. Further, in the present exemplary embodiment, a wired communication line is applied as the network N, but the present disclosure is not limited to this form. A wireless communication line may be applied, and a combination of the wired communication line and the wireless communication line may be applied.

As illustrated in FIG. 1, the server device 80 according to the present exemplary embodiment includes a storage unit 82, and the storage unit 82 stores a server print information database 82A. The storage unit 82 is realized by a hard disk drive (HDD), a solid state drive (SSD), a flash memory, or the like. The server print information database 82A will be described later in detail.

Further, the image forming device 90 according to the present exemplary embodiment includes a control unit 92, a user interface (UI) unit 94, and an image forming unit 96. Various types of information can be displayed and input by the UI unit 94, and various documents can be printed by the image forming unit 96.

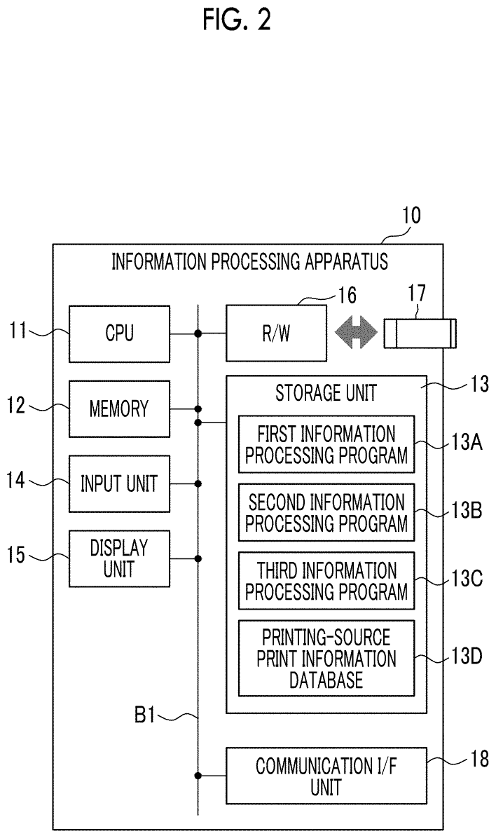

As described above, in the information processing system 1 according to the present exemplary embodiment, the information processing apparatus 10 transmits print data to the server device 80 in response to an instruction from a user while holding the print data in a storage unit 13 described later (also see FIG. 2). The information processing system 1 is configured to provide a cloud print service of causing an intended image forming device 90 to perform printing of an image indicated by the print data in a manner that the user performs a printing instruction to the image forming device 90. The information processing apparatus 10 according to the present exemplary embodiment is used by the above user.

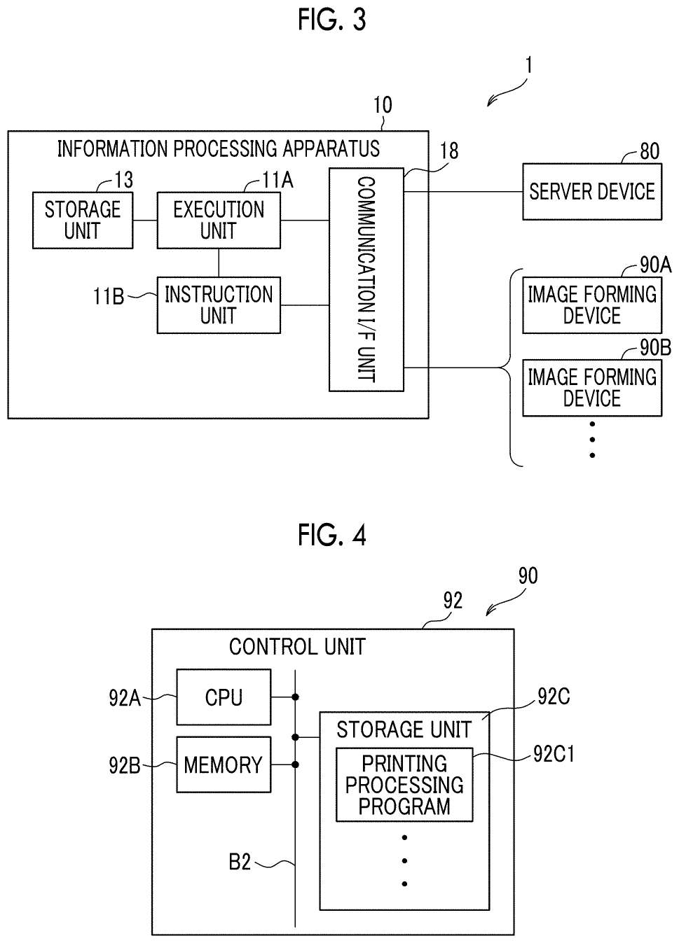

Next, the configuration of the information processing apparatus 10 according to the present exemplary embodiment will be described with reference to FIGS. 2 and 3. FIG. 2 is a block diagram illustrating an example of the hardware configuration of the information processing apparatus 10 according to the present exemplary embodiment. FIG. 3 is a block diagram illustrating an example of the functional configuration of the information processing apparatus 10 according to the present exemplary embodiment.

As illustrated in FIG. 2, the information processing apparatus 10 according to the present exemplary embodiment includes a central processing unit (CPU) 11 as a processor, a memory 12 as a temporary storage area, a non-volatile storage unit 13, an input unit 14 such as a keyboard, a display unit 15 such as a liquid crystal display, a medium reading and writing device (R/W) 16, and a communication interface (I/F) unit 18. The CPU 11, the memory 12, the storage unit 13, the input unit 14, the display unit 15, the medium reading and writing device 16, and the communication I/F unit 18 are connected to each other via a bus B1. The medium reading and writing device 16 reads out information written in a recording medium 17 and writes information in the recording medium 17.

The storage unit 13 according to the present exemplary embodiment is realized by an HDD, an SSD, a flash memory, or the like. The storage unit 13 as a storage medium stores a first information processing program 13A, a second information processing program 13B, and a third information processing program 13C.

The above information processing programs are stored (installed) in the storage unit 13 in a manner that the recording medium 17 in which each information processing program has been written is connected to the medium reading and writing device 16, and the medium reading and writing device 16 reads out each information processing program from the recording medium 17. The CPU 11 appropriately reads out the information processing programs from the storage unit 13, loads the programs into the memory 12, and sequentially executes processes of the programs.

Further, the storage unit 13 stores a printing-source print information database 13D. The printing-source print information database 13D will be described later in detail.

Next, the functional configuration of the information processing apparatus 10 according to the present exemplary embodiment will be described with reference to FIG. 3. As illustrated in FIG. 3, the information processing apparatus 10 includes an execution unit 11A and an instruction unit 11B. The CPU 11 in the information processing apparatus 10 executes each of the above programs to function as the execution unit 11A and the instruction unit 11B.

In a case where the execution unit 11A according to the present exemplary embodiment performs the cloud print service described above, and printing with print data has been ended at a predetermined timing, the execution unit 11A executes a process of deleting the print data from the storage unit 13. In the present exemplary embodiment, a timing for each predetermined period is applied as the predetermined timing.

Further, in the present exemplary embodiment, a case where a response result to an inquiry to the server device 80 indicates that the printing has been ended is applied as the case where the printing has been ended. In particular, in the present exemplary embodiment, information indicating all pieces of print data that have not been printed among pieces of print data received by the server device 80 is applied as the information indicating the response result.

Further, in a case where transmission of print data to an image forming device 90 in response to a transmission instruction of print data from the image forming device 90 has been ended, the execution unit 11A according to the present exemplary embodiment executes the process of deleting the print data from the storage unit 13.

In a case where transmission of print data to the image forming device 90 has been ended, the instruction unit 11B according to the present exemplary embodiment instructs the server device 80 to delete data related to the print data.

Next, the configuration of the control unit 92 in the image forming device 90 according to the present exemplary embodiment will be described with reference to FIG. 4. FIG. 4 is a block diagram illustrating an example of the hardware configuration of the control unit 92 in the image forming device 90 according to the present exemplary embodiment.

As illustrated in FIG. 4, the control unit 92 in the image forming device 90 according to the present exemplary embodiment includes a CPU 92A as a processor, a memory 92B as a temporary storage area, and a non-volatile storage unit 92C. The CPU 92A, the memory 92B, and the storage unit 92C are connected to each other via a bus B2.

The storage unit 92C according to the present exemplary embodiment is realized by an HDD, an SSD, a flash memory, or the like. The storage unit 92C as a storage medium stores a printing processing program 92C1. The CPU 92A appropriately reads out the printing processing program 92C1 from the storage unit 92C, loads the printing processing program 92C1 into the memory 92B, and sequentially executes processes of the printing processing program 92C1.

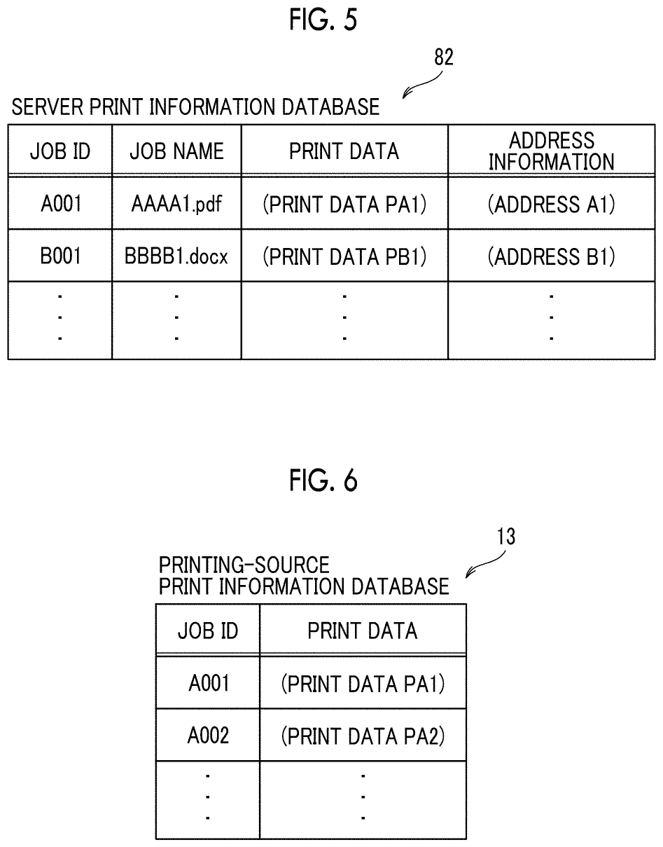

Next, the server print information database 82A stored in the server device 80 according to the present exemplary embodiment will be described with reference to FIG. 5. FIG. 5 is a schematic diagram illustrating an example of the configuration of the server print information database 82A according to the present exemplary embodiment.

The server print information database 82A according to the present exemplary embodiment is a database in which information related to print data received from the information processing apparatus 10 is registered. As illustrated in FIG. 5 as an example, types of information such as a job ID (Identification), a job name, print data, and address information are stored in association with each other.

The job ID is information given in advance as different for each print job, in order to individually specify the corresponding printing job. The job name is information indicating the name of the corresponding printing job. The printing job referred to here refers to a process unit of a printing operation performed by one instruction from an instructor. Further, in the present exemplary embodiment, a file name itself of an electronic file including the corresponding print data is applied as the job name. The present disclosure is not limited to this.

Further, the print data is information indicating an image to be printed in the corresponding printing job. The address information is information indicating the address of the information processing apparatus 10 used by the user who has instructed to perform printing by the corresponding printing job. In the present exemplary embodiment, the Internet protocol (IP) address of the corresponding information processing apparatus 10 is applied as the address information, but the present disclosure is not limited to this. For example, a form in which a media access control (MAC) address, identification information individually assigned to the information processing apparatus 10 in advance, or the like is applied as the address information may be made.

Next, a printing-source print information database 13D stored in the information processing apparatus 10 according to the present exemplary embodiment will be described with reference to FIG. 6. FIG. 6 is a schematic diagram illustrating an example of the configuration of the printing-source print information database 13D according to the present exemplary embodiment.

The printing-source print information database 13D according to the present exemplary embodiment is a database in which information related to print data transmitted to the server device 80 is registered. As illustrated in FIG. 6 as an example, types of information of a job ID and print data are stored in association with each other.

The job ID and the print data are types of information identical to a job ID and print data in the server print information database 82A described above, respectively. That is, in the information processing apparatus 10 according to the present exemplary embodiment, information other than the job name and the address information of the information processing apparatus 10 in information regarding the printing job transmitted from the information processing apparatus 10 to the server device 80 in response to an instruction of the user is stored in the printing-source print information database 13D.

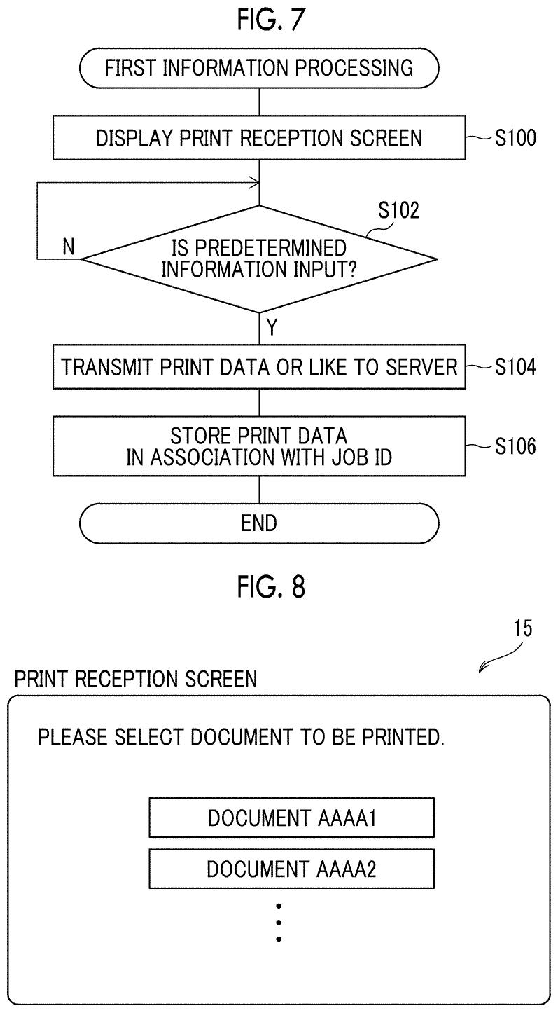

Next, the operation of the information processing system 1 according to the present exemplary embodiment will be described with reference to FIGS. 7 to 12.

First, the operation in a case where the information processing apparatus 10 according to the present exemplary embodiment performs first information processing will be described with reference to FIGS. 7 and 8. In a case where any image forming device 90 performs printing by using the cloud print service described above, and the user has performed an instruction input for an instruction to perform the first information processing to the information processing apparatus 10 used by the user, the CPU 11 in the information processing apparatus 10 executes a first information processing program 13A to perform the first information processing. FIG. 7 is a flowchart illustrating an example of the first information processing according to the present exemplary embodiment.

In Step S100 in FIG. 7, the CPU 11 controls the display unit 15 to display a print reception screen having a predetermined configuration. In Step S102, the CPU 11 waits until predetermined information is input. FIG. 8 illustrates an example of the print reception screen according to the present exemplary embodiment.

As illustrated in FIG. 8, a message for urging selection of a document to be printed is displayed on the print reception screen according to the present exemplary embodiment. Further, information representing a document that can be printed by the user is displayed in a state where the information can be selected by the user, on the print reception screen according to the present exemplary embodiment.

In a case where the print reception screen illustrated in FIG. 8 is displayed on the display unit 15, the user designates a display area for information representing the document to be printed, via the input unit 14. In a case where the display area is designated by the user, Step S102 is determined to be positive, and the process proceeds to Step S104.

In Step S104, the CPU 11 transmits print data indicating the document designated by the user to the server device 80 together with the job ID, the job name, and the address information described above.

In Step S106, the CPU 11 stores a job ID and print data identical to the job ID and the print data transmitted to the server device 80 in the process of Step S104, in the printing-source print information database 13D. Then, the present first information processing is ended.

As described above, in the information processing system 1 according to the present exemplary embodiment, with the first information processing, the user designates the document to be printed, so as to transmit the print data or the like indicating the designated document to the server device 80 and store the print data and the job ID in the storage unit 13 of the information processing apparatus 10. The present disclosure is not limited to this form. For example, a form in processes similar to the processes of the first information processing is applied to a form of performing printing of a document by using a printing function in a general application program such as MICROSOFT OFFICE (registered trademark) may be made. As an example of the form in this case, a form in which with a printer driver, print data or the like indicating the document is transmitted to the server device 80 and the print data and the job ID are stored in the storage unit 13 of the information processing apparatus 10 can be exemplified.

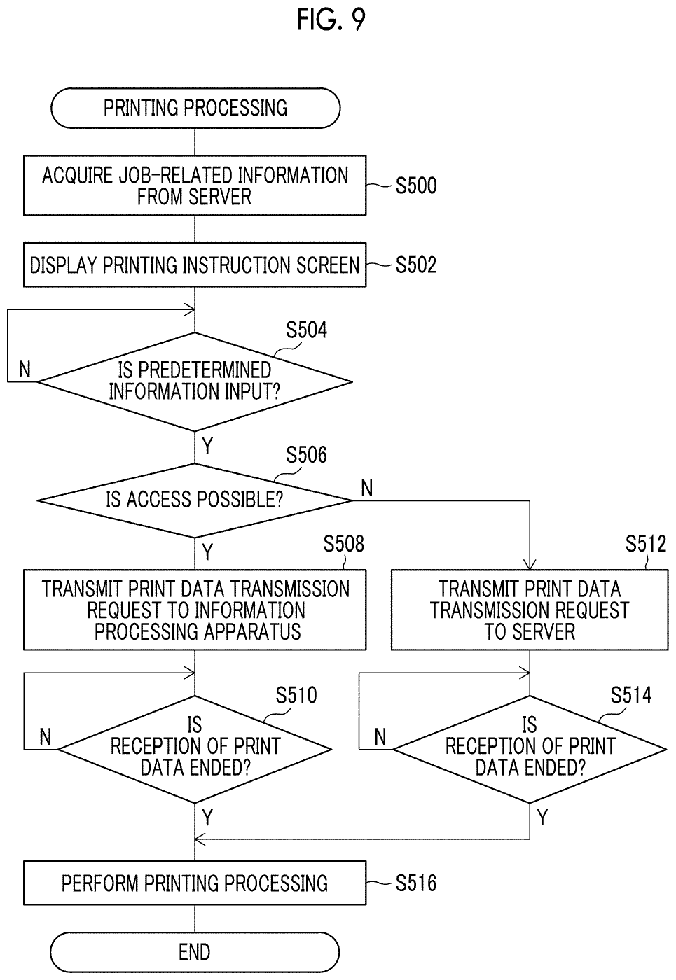

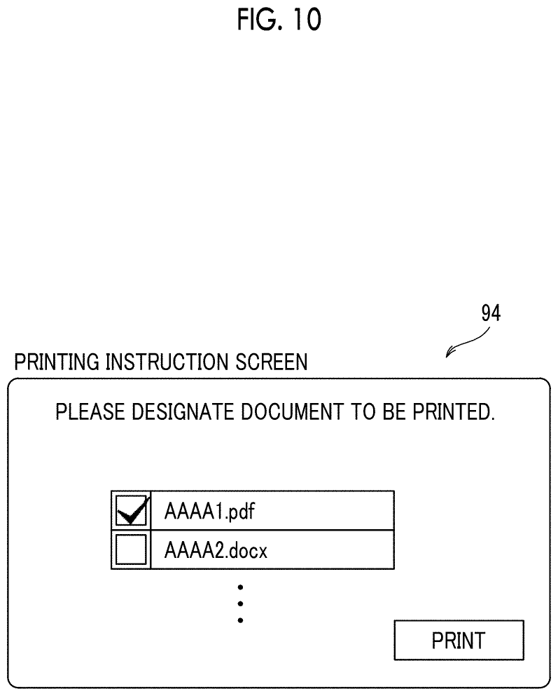

Next, the operation in a case where the image forming device 90 according to the present exemplary embodiment performs printing processing will be described with reference to FIGS. 9 to 10. In a case where any image forming device 90 performs printing by using the cloud print service described above, the user moves to the installation location of the intended image forming device 90. In a case where the user has logged into the image forming device 90, the CPU 92A in the image forming device 90 executes the printing processing program 92C1 to perform the printing processing. FIG. 9 is a flowchart illustrating an example of the printing processing according to the present exemplary embodiment.

In Step S500 in FIG. 9, the CPU 92A specifies a printing job related to a user (referred to as a “printing instruction user” below) by using authentication information acquired from the user at time of logging in, and reads out information (referred to as “job-related information” below) indicating all job IDs and all job names related to the specific printing job, from the server print information database 82A in the server device 80. In the present exemplary embodiment, the printing job related to the printing instruction user is specified in a manner that the address information of the information processing apparatus 10 used by the corresponding user is stored in the storage unit 92C in the image forming device 90, in advance in association with the authentication information, and the printing job corresponding to the address information is specified. The method of specifying the printing job related to the printing instruction user is not limited to this method. For example, a form in which a job ID is generated as information (referred to as “specific information” below) that can identify a user who has performed a printing instruction, the specific information of the corresponding user is stored in advance in the storage unit 92C of the image forming device 90 in association with the authentication information, and a printing job corresponding to the specific information is specified may be made.

In Step S502, the CPU 92A controls the UI unit 94 to display a printing instruction screen having a predetermined configuration by using the read job-related information. In Step S504, the CPU 92A waits until predetermined information is input. FIG. 10 illustrates an example of the printing instruction screen according to the present exemplary embodiment.

As illustrated in FIG. 10, a message for urging designation of a document to be printed is displayed on the printing instruction screen according to the present exemplary embodiment. Further, information indicating all the job names indicated by the read job-related information is displayed on the printing instruction screen according to the present exemplary embodiment, in a state where the information can be designated by the printing instruction user.

In a case where the printing instruction screen illustrated in FIG. 10 is displayed on the UI unit 94, the printing instruction user designates a display area for the job name corresponding to the document to be printed, via the UI unit 94B. In a case where the display area is designated by the printing instruction user, Step S504 is determined to be positive, and the process proceeds to Step S506.

In Step S506, the CPU 92A attempts to access the address indicated by the address information applied in a case where the printing job is specified in Step S500, so as to determine whether or not an access to the information processing apparatus 10 (referred to as a “printing instruction apparatus” below) used by the printing instruction user is possible. In a case where the positive determination is made, the process proceeds to Step S508. In a case where the address information is not applied in a case where the printing job is specified and the above specific information is applied, a form in which the corresponding address information is read out together with the job-related information in Step S500, and thus the address information used in the process of Step S506 is acquired may be made.

In Step S508, the CPU 92A transmits request information for requesting the printing instruction apparatus to transmit print data corresponding to the job ID in the job-related information of the document designated by the printing instruction user. Upon receiving the request information, the printing instruction apparatus transmits the corresponding print data to the image forming device 90 as an access source.

Thus, in Step S510, the CPU 92A waits until reception of the print data from the printing instruction apparatus is ended, and then the process proceeds to Step S516.

On the other hand, in a case where a negative determination is made in the process of Step S506, it is considered that the access to the printing instruction apparatus is not possible. Then, the process proceeds to Step S512.

In Step S512, the CPU 92A transmits request information for requesting the server device 80 to transmit the print data corresponding to the job ID in the job-related information of the document designated by the printing instruction user. Upon receiving the request information, the server device 80 transmits the corresponding print data to the image forming device 90 as the access source, and deletes information related to the print data from the server print information database 82A.

Thus, in Step S514, the CPU 92A waits until reception of the print data from the server device 80 is ended, and then the process proceeds to Step S516.

In Step S516, the CPU 92A controls the image forming unit 96 to perform printing with the print data received in the process of Step S510 or S514. Then, the CPU 92A ends the present printing processing.

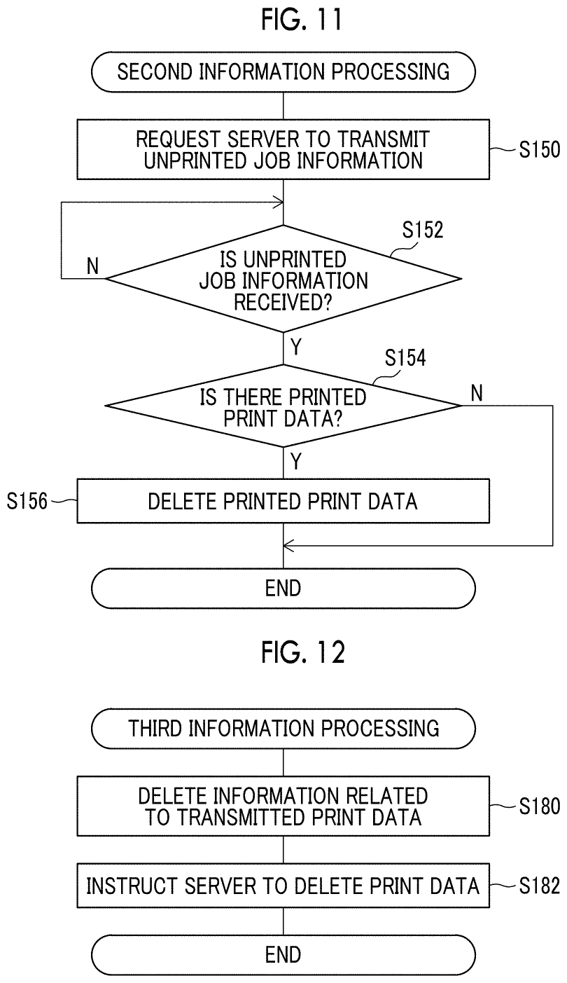

Next, the operation in a case where the information processing apparatus 10 according to the present exemplary embodiment performs second information processing will be described with reference to FIG. 11. The second information processing is performed in a manner that the CPU 11 of each information processing apparatus 10 executes the second information processing program 13B for each predetermined period (10 minutes in the present exemplary embodiment). FIG. 11 is a flowchart illustrating an example of the second information processing according to the present exemplary embodiment.

In Step S150 in FIG. 11, the CPU 11 transmits request information for requesting the server device 80 to transmit information (referred to as “unprinted job information” below) indicating all pieces of print data of which printing has not been ended among pieces of the print data received by the server device 80 from each information processing apparatus 10. Upon receiving the request information, the server device 80 transmits the unprinted job information to the information processing apparatus 10 as the access source. In the present exemplary embodiment, the job ID stored in the server print information database 82A is applied as the unprinted job information, but the present disclosure is not limited to this. For example, a form in which the job name stored in the server print information database 82A is applied as the unprinted job information may be made, or a form in which both the job ID and the job name are applied as the unprinted job information may be made.

Thus, in Step S152, the CPU 11 waits until the reception of the unprinted job information from the server device 80 is ended. In Step S154, the CPU 11 determines, with reference to the received unprinted job information, whether or not the print data stored in the printing-source print information database 13D includes the print data of which printing has been already ended. In a case where the positive determination is made, the process proceeds to Step S156. In the present exemplary embodiment, the determination in Step S154 is made by determining whether or not the printing-source print information database 13D stores print data corresponding to the job ID that is not included in the received unprinted job information. The present disclosure is not limited to this form.

In Step S156, the CPU 11 deletes the print data of which printing is determined to be already ended in the process of Step S154 and the job ID corresponding to the print data, from the printing-source print information database 13D. Then, the present second information processing is ended.

On the other hand, in a case where a negative determination is made in the process of Step S154, it is considered that the printing-source print information database 13D does not include the print data of which printing has been ended, and the present second information processing is ended without deleting the print data and the like in Step S156.

Next, the operation in a case where the information processing apparatus 10 according to the present exemplary embodiment performs third information processing will be described with reference to FIG. 12. The third information processing is performed in a manner that the CPU 11 in the information processing apparatus 10 executes the third information processing program 13C in a case where any piece of print data (referred to as “transmission print data” below) stored in the printing-source print information database 13D is transmitted to any image forming device 90. FIG. 12 is a flowchart illustrating an example of the third information processing according to the present exemplary embodiment.

In Step S180 in FIG. 12, the CPU 11 deletes the transmission print data and the job ID corresponding to the transmission print data from the printing-source print information database 13D. In Step S182, the CPU 11 transmits the instruction information for instructing the server device 80 to delete information related to the deleted transmission print data, to the server device 80. Then, the third information processing is ended. Upon receiving the instruction information, the server device 80 deletes information (in the present exemplary embodiment, job ID, job name, print data, and address information) related to transmission print data indicated by the instruction information, from server print information database 82A.

In the above exemplary embodiment, the case where, with the second information processing, the information processing apparatus 10 inquires the server device 80 of information indicating all pieces of the print data that have not been printed among pieces of the print data received by the server device 80, and information related to the printed print data is deleted by using the response result has been described. The present disclosure is not limited to this. For example, a form in which the information processing apparatus 10 inquires the server device 80 of information indicating the printing status of the individual print data, and deletes the information related to the printed print data by using the response result may be made.

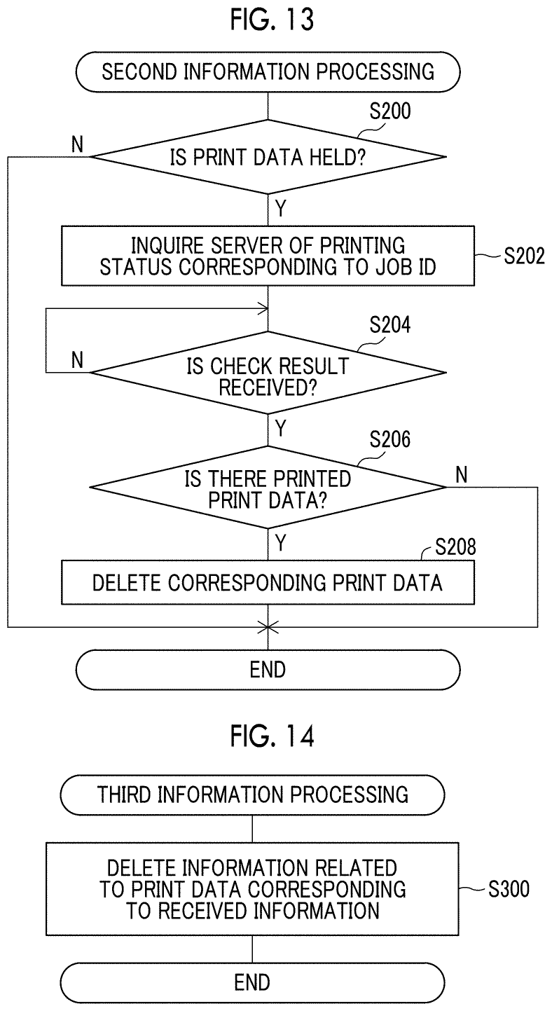

FIG. 13 illustrates a flowchart illustrating an example of the second information processing in a case where this form is applied. The operation in a case where the information processing apparatus 10 performs the second information processing in this case will be described later with reference to FIG. 13. The second information processing is performed in a manner that the CPU 11 in the information processing apparatus 10 executes the second information processing program 13B at three types of timings being timings at which the user has logged into or logged out from the information processing apparatus 10, and a timing at which the user has issued an instruction to perform the first information processing.

In Step S200 in FIG. 13, the CPU 11 determines whether or not the print data is stored in the printing-source print information database 13D. In a case where the negative determination is made, the present second information processing is ended. In a case where the positive determination is made, the process proceeds to Step S202.

In Step S202, the CPU 11 reads out the job ID corresponding to the print data stored in the process of Step S200, from the printing-source print information database 13D. Then, in Step S202, the CPU 11 inquires of the server device 80 whether or not printing with the print data corresponding to the read job ID is ended. Upon receiving this inquiry, the server device 80 checks whether or not printing with the print data corresponding to the job ID targeted for the inquiry has been ended by any image forming device 90, and transmits information (referred to as “check result information” below) indicating the check result, to the information processing apparatus 10 as the access source. In the present exemplary embodiment, the above check is performed by checking whether or not the print data corresponding to the job ID targeted for the above inquiry is stored in the server print information database 82A. The present disclosure is not limited to this.

Therefore, in Step S204, the CPU 11 waits until the check result information is received from the server device 80. In Step S206, the CPU 11 determines whether or not there is print data of which printing has been ended, from the check result indicated by the received check result information. In a case where the negative determination is made, the present second information processing is ended. In a case where the positive determination is made, the process proceeds to Step S208.

In Step S208, the CPU 11 deletes the print data of which printing is determined to be ended in the process of Step S206 and the job ID corresponding to the print data, from the printing-source print information database 13D. Then, the present second information processing is ended.

In this embodiment, a case where the present second information processing is performed at three types of timings: the timings at which the user has logged into and logged out from the information processing apparatus 10, and the timing at which the user has issued an instruction to perform the first information processing. The present disclosure is not limited to this form. For example, a form in which one or a combination of two types among the three types of timings is applied as the timing for performing the present second information processing may be made.

Further, in the above exemplary embodiment, the case where the information related to the print data is deleted in a case where the print data is directly transmitted to the server device 80 by the third information processing has been described, but the present disclosure is not limited to this. For example, a form in which, in response to reception of information from the server device 80 or the image forming device 90 that printing has been ended, the information related to the corresponding print data is deleted may be made.

In the case of this embodiment, in a case where printing with the print data received from the server device 80 has been ended by any image forming device 90, information (referred to as “print end information” below) indicating that printing with the print data from any of the server device 80 or the image forming device 90 has been ended is transmitted to the corresponding information processing apparatus 10.

FIG. 14 illustrates a flowchart illustrating an example of the third information processing in a case where this form is applied. The operation in a case where the information processing apparatus 10 performs the third information processing in this case will be described later with reference to FIG. 14. The third information processing is performed in a manner that the CPU 11 in the information processing apparatus 10 executes the third information processing program 13C in a case where the print end information is received.

In Step S300 in FIG. 14, the CPU 11 deletes the print data indicated by the received print end information and the job ID corresponding to the print data, from the printing-source print information database 13D. Then, the present third information processing is ended.

Although the exemplary embodiment has been described above, the technical scope of the present invention is not limited to the scope described in the above exemplary embodiments. Various changes or improvements may be made to the above exemplary embodiments without departing from the gist of the invention, and the changed or improved modes are also included in the technical scope of the invention.

Further, the above exemplary embodiment does not limit the invention according to the claim, and not all combinations of characteristics described in the exemplary embodiments are not limited to being required for the means for addressing the invention. The above-described exemplary embodiment includes inventions at various stages, and various inventions are extracted by combining a plurality of disclosed constituent requirements. Even though some constituent requirements are deleted from all the constituent requirements described in the exemplary embodiment, a configuration in which some of the constituent requirements are deleted may be extracted as an invention as long as the effect is obtained.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In addition, the configuration of the information processing apparatus 10 described in the above exemplary embodiment is an example. An unnecessary portion may be deleted or a new portion may be added, within a range without departing from the gist of the present invention.

Further, the flow of the processing described in each exemplary embodiment is also an example. An unnecessary step may be deleted, a new step may be added, or the processing order may be changed, within a range without departing from the gist of the present invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
in a case where an intended image forming device is caused to perform printing of an image indicated by print data via a server device in a manner that the print data is transmitted to the server device in response to an instruction from a user while the print data is held in a storage unit, and then a printing instruction is performed on the image forming device by the user, and printing with the print data has been ended at a predetermined timing, execute a process of deleting the print data from the storage unit.

2. The information processing apparatus according to claim 1,
wherein the predetermined timing is at least one of a timing at which a predetermined operation is performed on the information processing apparatus or a timing for each predetermined period.

3. The information processing apparatus according to claim 2,
wherein the predetermined operation is at least one of an operation for the instruction on the image forming device or an operation of at least one of login to or logout from the information processing apparatus.

4. The information processing apparatus according to claim 1,
wherein the case where the printing has been ended is a case where a response result to an inquiry to the server device indicates that the printing has been ended.

5. The information processing apparatus according to claim 2,
wherein the case where the printing has been ended is a case where a response result to an inquiry to the server device indicates that the printing has been ended.

6. The information processing apparatus according to claim 3,
wherein the case where the printing has been ended is a case where a response result to an inquiry to the server device indicates that the printing has been ended.

7. The information processing apparatus according to claim 4,
wherein information indicating the response result is at least one of information indicating a printing status of individual print data or information indicating all pieces of print data that have not been printed among pieces of print data received by the server device.

8. The information processing apparatus according to claim 5,
wherein information indicating the response result is at least one of information indicating a printing status of individual print data or information indicating all pieces of print data that have not been printed among pieces of print data received by the server device.

9. The information processing apparatus according to claim 6,
wherein information indicating the response result is at least one of information indicating a printing status of individual print data or information indicating all pieces of print data that have not been printed among pieces of print data received by the server device.

10. The information processing apparatus according to claim 1, wherein the processor is configured to:
in a case where transmission of the print data to the image forming device in response to a transmission instruction of the print data from the image forming device has been ended, execute the process of deleting the print data from the storage unit.

11. The information processing apparatus according to claim 2, wherein the processor is configured to:
in a case where transmission of the print data to the image forming device in response to a transmission instruction of the print data from the image forming device has been ended, execute the process of deleting the print data from the storage unit.

12. The information processing apparatus according to claim 3, wherein the processor is configured to:
in a case where transmission of the print data to the image forming device in response to a transmission instruction of the print data from the image forming device has been ended, execute the process of deleting the print data from the storage unit.

13. The information processing apparatus according to claim 4, wherein the processor is configured to:
in a case where transmission of the print data to the image forming device in response to a transmission instruction of the print data from the image forming device has been ended, execute the process of deleting the print data from the storage unit.

14. The information processing apparatus according to claim 5, wherein the processor is configured to:
in a case where transmission of the print data to the image forming device in response to a transmission instruction of the print data from the image forming device has been ended, execute the process of deleting the print data from the storage unit.

15. The information processing apparatus according to claim 6, wherein the processor is configured to:
in a case where transmission of the print data to the image forming device in response to a transmission instruction of the print data from the image forming device has been ended, execute the process of deleting the print data from the storage unit.

16. The information processing apparatus according to claim 7, wherein the processor is configured to:
in a case where transmission of the print data to the image forming device in response to a transmission instruction of the print data from the image forming device has been ended, execute the process of deleting the print data from the storage unit.

17. The information processing apparatus according to claim 10, wherein the processor is configured to:
in a case where the transmission of the print data to the image forming device has been ended, instruct the server device to delete data related to the print data.

18. The information processing apparatus according to claim 1, wherein the processor is configured to:
in a case where information indicating an end of printing is received from at least one of the server device or the image forming device, execute the process of deleting the print data corresponding to the printing, from the storage unit.

19. A non-transitory computer readable medium storing an information processing program causing a computer to execute a process comprising:
executing, in a case where an intended image forming device is caused to perform printing of an image indicated by print data via a server device in a manner that the print data is transmitted to the server device in response to an instruction from a user while the print data is held in a storage unit, and then a printing instruction is performed on the image forming device by the user, and printing with the print data has been ended at a predetermined timing, a process of deleting the print data from the storage unit.

20. An information processing method comprising:
executing, in a case where an intended image forming device is caused to perform printing of an image indicated by print data via a server device in a manner that the print data is transmitted to the server device in response to an instruction from a user while the print data is held in a storage unit, and then a printing instruction is performed on the image forming device by the user, and printing with the print data has been ended at a predetermined timing, a process of deleting the print data from the storage unit.
